(19) United States
(12) Patent Application Publication
(10) Pub. No.: US 2011/0260362 A1
(43) Pub. Date: Oct. 27, 2011

(54) WIND TURBINE BLADE MANUFACTURING ARRANGEMENT

(75) Inventor: Leif Kappel Petersen, Lem St (DK)

(73) Assignee: VESTAS WIND SYSTEMS A/S, Randers SV (DK)

(21) Appl. No.: 13/088,816

(22) Filed: Apr. 18, 2011

Related U.S. Application Data
(60) Provisional application No. 61/327,137, filed on Apr. 23, 2010.

(30) Foreign Application Priority Data
Apr. 22, 2010 (DK) PA 2010 70162

(51) Int. Cl. B28B 7/04; B28B 17/00

(52) U.S. Cl. 264/294; 425/188

(57) ABSTRACT

A wind turbine blade manufacturing arrangement includes a first mould and a second mould connected by a hinge mechanism and presenting respective elongated first and second moulding surfaces. The first mould is adapted to be rotated from an open mould position to a mould closing position by means of the hinge mechanism in a first and a second rotation step. The hinge mechanism is arranged so as to provide for, during at least a part of the first rotation step, the first mould undergoing a combined rotational and a translational movement.

### CROSS-REFERENCE TO RELATED APPLICATIONS

This application claims priority under 35 U.S.C. §119(a) to DK Application No. PA 2010 70162, filed Apr. 22, 2010. This application also claims the benefit of U.S. Provisional Application Ser. No. 61/327,137, filed Apr. 23, 2010. Each of these applications is incorporated by reference herein in its entirety.

### TECHNICAL FIELD

The invention relates to a wind turbine blade manufacturing arrangement comprising a first mould and a second mould connected by a hinge mechanism and presenting respective elongated first and second moulding surfaces. The invention also relates to a method for manufacturing a wind turbine blade.

### BACKGROUND

A general trend in wind turbine industry is for the turbines to become larger. This entails some issues for the manufacturing of the blades, which can exceed 50 metres in length. With such large items, there is a desire to keep the required factory space down, since such space represents large investments for manufacturers.

A wind turbine blade is often manufactured in two elongated moulds placed laterally beside each other with their longitudinal directions substantially parallel, at which the moulds are connected with some kind of hinge mechanism. In the moulds, respective pressure and suction side shells are laid up in fibre reinforced plastics, e.g. glass and epoxy. This is done with the mould surfaces facing upwards. After curing, the shells are bonded to each other, usually with a spar or similar structural reinforcement element placed between them. For this assembly of the shells, by means of the hinge mechanism one of the moulds is turned, with the cured shell in it, onto the top of the other mould so that the mould surfaces are facing each other, and the shells are brought together with adhesive in suitable locations. Variants of such a process are described in DK200200306U3 and EP1562733B1.

WO2007/054088 suggests, in order to reduce the required height, a blade manufacturing arrangement with a two axis hinge mechanism, whereby one of the moulds is turned about halfway around one of the axes, and the rest of the way around the other axis. Although this could reduce the height required for the turning step, such an arrangement would require a relatively large horizontal extension in the lateral direction of the moulds, allowing enough room for the double axis hinge mechanism before turning, when the mould surfaces are faced upwards.

### SUMMARY

Various embodiments of the invention improve manufacturing of wind turbine blades. Various embodiments of the invention also reduce the space required to manufacture wind turbine blades.

In one embodiment, a wind turbine blade manufacturing arrangement comprises a first mould and a second mould connected by a hinge mechanism and presenting respective elongated first and second moulding surfaces, wherein the first mould is adapted to be rotated from an open mould position to a mould closing position by means of the hinge mechanism in a first and a second rotation step. The hinge mechanism is arranged so as to provide for, during at least a part of the first rotation step, the first mould undergoing a combined rotational and a translational movement.

The first mould rotates during the first and a second rotation step around a first and a second axis of rotation, respectively. In WO2007/054088, the axis of rotation for the mould being turned remains fixed during each step of the rotation. An embodiment of the invention introduces a combined rotational and a translational movement, during which the first axis of rotation moves. Thereby, it is possible for the hinge mechanism to be arranged so as to provide for the first mould, in particular the centre of gravity thereof, to be translated, in the first rotation step, away from the second mould. This in turn will allow the first and second mould parts to be located close to each other in the open mould position of the first mould, which will make it possible to keep the width of the entire blade manufacturing arrangement, while retaining the benefit of the low height requirement provided by the double rotational axis hinge mechanism.

The first mould part can also, during the first rotation step, move away from the second mould part, since the distance between the first axis of rotation and the second mould, during at least a part of the first rotation step, is larger than the distance between the first mould and the second mould.

It is understood that the first and second moulding surfaces extend in a longitudinal direction from a respective root end to a respective tip end, which correspond to respective root and tip ends of the blades manufactured in the blade manufacturing arrangement. According to this presentation, a transverse direction is defined as extending perpendicularly to the longitudinal direction, from a location of a blade leading edge to a location of a blade a trailing edge. It is further understood that the longitudinal directions of the first and second moulding surfaces are substantially parallel, and the second mould surface is oriented so as to face substantially upwards.

It is also understood that the first and second axes of rotation are substantially parallel to the longitudinal direction of the first moulding surface, and that they are non-coinciding, but normally substantially parallel. Also, in the open mould position, the first moulding surface is facing substantially upwards, and in the mould closing position, the first moulding surface is located above the second moulding surface, and the first and second moulding surfaces are facing each other. Further, it is understood that during the first rotation step, the first mould is rotated from the open mould position to an intermediate position in which the first moulding surface is turned towards the second mould part. Moreover, during the second turning step, the first mould is rotated from the intermediate position to the mould closing position.

In one embodiment, the hinge mechanism comprises at least one rotation element which, at a first element connection, is rotationally connected to a fixing unit which is adapted to remain fixed during the first rotation step, and at a second element connection, is rotationally connected to the first mould. The distance between the second element connection and the second mould is, at least during the open mould position of the first mould, shorter than the distance between the first element connection and the second mould.

In one embodiment, the axes of rotation at the first and second element connections are parallel to the first axis of rotation. The fixing unit could be a part of the hinge mechanism, or it could be a separate unit, e.g., connected to the floor in the building in which the manufacturing arrangement is located.

In one embodiment, the distance between the centre of gravity of the first mould and the second mould is shorter than the distance between the second element connection and the second mould. In one embodiment, the rotation element is adapted to rotate in the opposite direction in relation to the first mould. In one embodiment, the hinge mechanism comprises at least one drive unit adapted to act, during the first rotation step, on the at least one rotation element so as the urge the rotation element to rotate about the first element connection. In one embodiment, the distance between the second axis of rotation and the second mould is, at least in the open mould position, shorter than the distance between the second element connection and the second mould. In one embodiment, the first mould is provided with at least one roller adapted to carry at least a portion of the weight of the first mould, the distance between the roller and the second mould being shorter than the distance between the second element connection and the second mould, at least in the open mould position. In one embodiment, the distance between the roller and the second mould is shorter than the distance between the centre of gravity of the first mould and the second mould, at least in the open mould position.

In another embodiment, a method for manufacturing a wind turbine blade using a manufacturing arrangement having a first mould and a second mould connected by a hinge mechanism and presenting respective elongated first and second moulding surfaces includes rotating the first mould, from an open mould position to a mould closing position, in a first and a second rotation step, wherein in at least a part of the first rotation step, the first mould undergoes a combined rotational and a translational movement.

### BRIEF DESCRIPTION OF THE DRAWINGS

Below, embodiments of the invention will be described with reference to the drawings, in which:

FIG. 1 is a side view of a wind turbine blade manufacturing arrangement;

FIG. 2 is another side view of the wind turbine blade manufacturing arrangement;

FIG. 3 is another side view of the wind turbine blade manufacturing arrangement;

FIG. 4 is another side view of the wind turbine blade manufacturing arrangement; and

FIG. 5 is a schematic side view of the wind turbine blade manufacturing arrangement shown in FIGS. 1-3.

### DETAILED DESCRIPTION

FIG. 1 shows a wind turbine blade manufacturing arrangement 1 comprising a first mould 2 and a second mould 3 connected by a hinge mechanism 4. The moulds 2, 3 present respective elongated first and second moulding surfaces 21, 31, extending in respective longitudinal parallel directions “into the paper presenting FIG. 1”. In FIG. 1, the first mould 2 is in an open mould position in which the first and second mould surfaces 21, 31 are oriented so as to face upwards.

As detailed below, the first mould 2 is adapted to be rotated from the open mould position to a mould closing position by means of the hinge mechanism 4 in a first and a second rotation step, around a first and a second axis of rotation, respectively.

The hinge mechanism 4 comprises a plurality of rotation elements 41, which are distributed along the longitudinal direction of the first mould 2, and of which only one is shown in FIG. 1. The rotation elements 41 are at respective first element connections 411 rotationally connected to a fixing unit 42 of the hinge mechanism 4. The fixing unit 42 is adapted to remain fixed during the first rotation step. The rotation elements 41 are at respective second element connections 412 rotationally connected to the first mould 2. The distance between the second element connections 412 and the second mould 3 is, in the open mould position of the first mould 2, shorter than the distance between the first element connections 411 and the second mould 3.

It should be noted that, in the open mould position, the distance between the centre of gravity CG2 of the first mould 2 and the second mould 3 is preferably shorter than the distance between the second element connections 412 and the second mould 3.

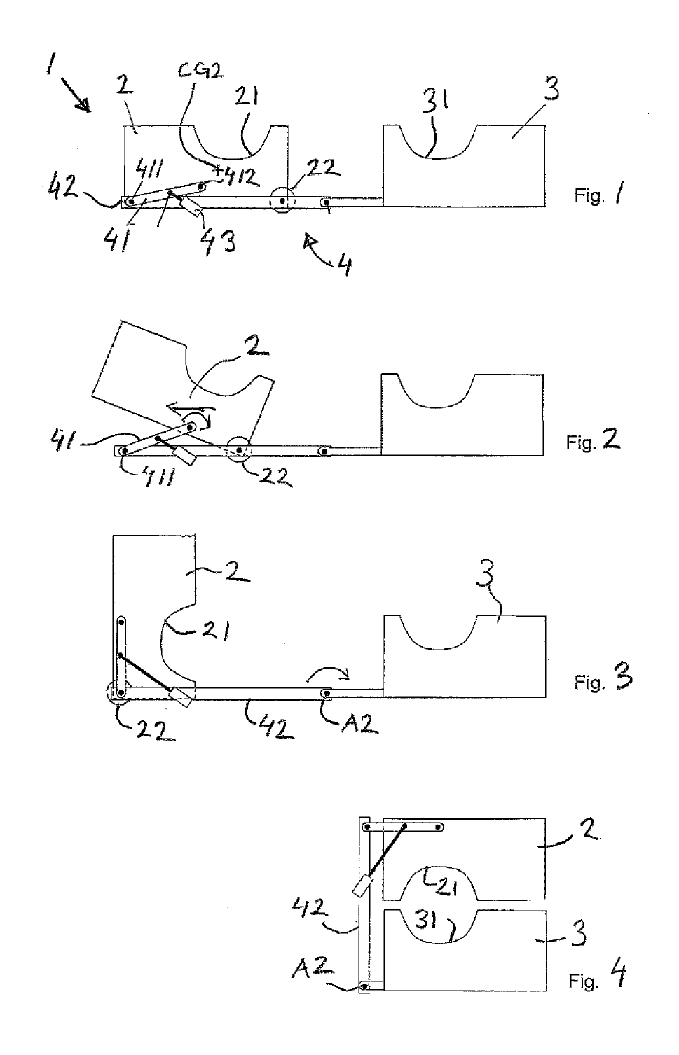

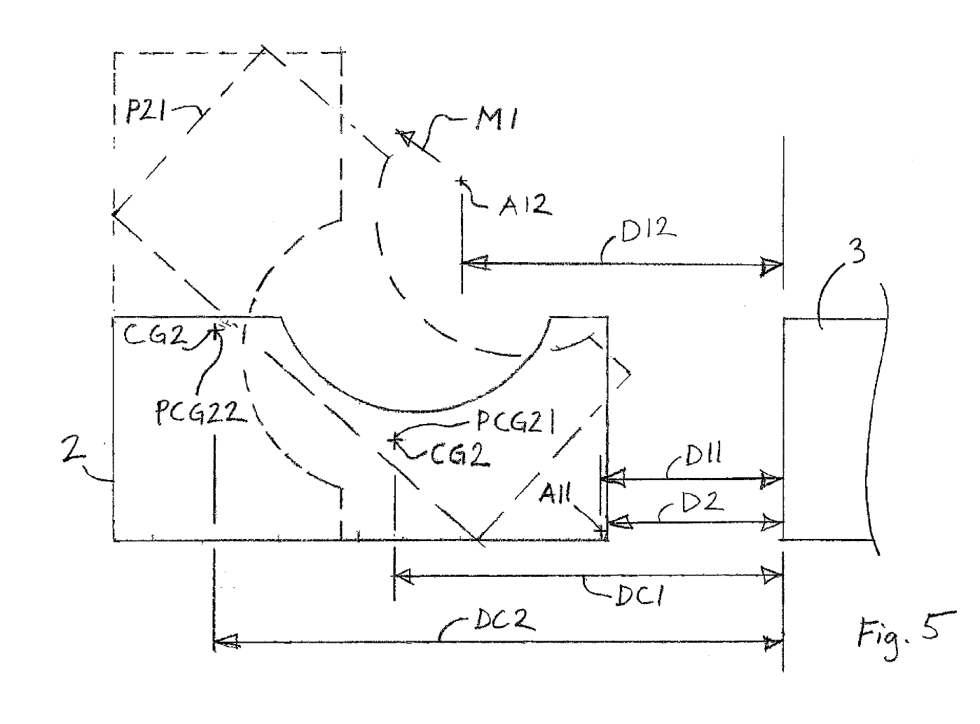

Reference is made also to FIG. 2 and FIG. 3. For each of the rotation elements 41, the hinge mechanism comprises a drive unit 43, which is adapted to act between the fixing unit 42 and the respective rotation element 41, so as the urge the rotation element 41 to rotate about the first element connection 411. This will cause the first mould 2 to rotate in the opposite direction, as indicated in FIG. 2, to end up in an intermediate position as shown in FIG. 3, in which the first moulding surface 21 is turned towards the second mould 3. The drive unit 43 can be of any suitable kind, for example a hydraulic actuator or an electric motor.

For this first rotation step, the first mould 2 is provided with a plurality of rollers 22, of which only one is shown in the figures, distributed in the longitudinal direction of the first mould 2. In the open mould position shown in FIG. 1, the distance between the rollers 22 and the second mould 3 is shorter than the distance between the second element connections 412 and the second mould 3. Also, in the open mould position the distance between the rollers 22 and the second mould 3 is shorter than the distance between the centre of gravity of the first mould 2 and the second mould 3. During the first rotation step, the rollers 22 will carry a portion of the weight of the first mould 2 and they will move in a direction away from the second mould 3.

As can be seen in FIG. 4, during the second turning step, the first mould 2 is rotated around the second axis A2 from the intermediate position to a mould closing position, in which the first moulding surface 21 is located above the second moulding surface 31, and the first and second moulding surfaces are facing each other. The second axis A2 is provided by an articulated joint of the hinge mechanism between the fixing unit 42 and the second mould 3. The distance between the second axis A2 and the second mould 3 is, in the open mould position (FIG. 1), shorter than the distance between the rotation elements 41 and the second mould 3.

It should be noted that the manufacturing arrangement 1 is in this embodiment adapted to provide, after the first mould 2 has reached the mould closing position shown in FIG. 4, a relatively short translational movement, (not illustrated), of the first mould 2 so as to bring the first and second moulding surfaces 21, 31 closer to each other. This translational movement will finally close the manufacturing arrangement, at a manufacturing stage where cured wind blade shells in the moulds 2, 3 are bonded together with a spar located between them.

Reference is made to FIG. 5. During the first rotation step, the first mould 2 undergoes a combined rotational and a translational movement, and the centre of gravity CG2 of the first mould 2 is translated from the position indicated as PCG21 to the position indicated as PCG22. Thus, the distance between the centre of gravity CG2 of the first mould 2 and the second mould 3 is increased, (as indicated by the double arrows DC1, DC2).

FIG. 5 also indicates schematically how the first axis of rotation moves during the first rotation step. Such a moving axis of rotation is sometimes referred to as an instant centre of rotation. When the first mould 2 starts rotating, the first axis of rotation is located approximately as indicated by the cross A11. When the first mould 2 is in a position indicated with broken lines P21, the first axis of rotation is located as indicated by the cross A12. As the first mould rotation continues, the first axis of rotation moves in a direction approximately indicated by the arrow M1. It can be seen that during the first rotation step, the first axis of rotation A11, A12 moves away from the second mould 3, and also upwards.

While the invention has been illustrated by a description of the various embodiments, and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of the general inventive concept.

What is claimed is:

1. A wind turbine blade manufacturing arrangement, comprising:
a first mould; and
a second mould connected to the first mould by a hinge mechanism, the first and second moulds presenting respective elongated first and second moulding surfaces,
wherein the first mould is adapted to be rotated from an open mould position to a mould closing position by means of the hinge mechanism in a first and a second rotation step, and
wherein the hinge mechanism is configured so as to provide for, during at least a part of the first rotation step, the first mould undergoing a combined rotational and a translational movement.

2. The wind turbine blade manufacturing arrangement according to claim 1, wherein the hinge mechanism is configured so as to provide for the first mould being translated, in the first rotation step, away from the second mould.

3. The wind turbine blade manufacturing arrangement according to claim 1, wherein the hinge mechanism comprises at least one rotation element which at a first element connection is rotationally connected to a fixing unit which is adapted to remain fixed during the first rotation step, and at a second element connection is rotationally connected to the first mould, the distance between the second element connection and the second mould being, at least during the open mould position of the first mould, shorter than the distance between the first element connection and the second mould.

4. The wind turbine blade manufacturing arrangement according to claim 3, wherein the distance between the centre of gravity of the first mould and the second mould is shorter than the distance between the second element connection and the second mould.

5. The wind turbine blade manufacturing arrangement according to claim 3, wherein the rotation element is adapted to rotate in the opposite direction in relation to the first mould.

6. The wind turbine blade manufacturing arrangement according to claim 3, wherein the hinge mechanism comprises at least one drive unit adapted to act, during the first rotation step, on the at least one rotation element so as the urge the rotation element to rotate about the first element connection.

7. The wind turbine blade manufacturing arrangement according to claim 3, wherein the first mould is adapted to rotate during the first and second rotation steps around a first and a second axis of rotation, respectively, and the distance between the second axis of rotation and the second mould is, at least in the open mould position, shorter than the distance between the second element connection and the second mould.

8. The wind turbine blade manufacturing arrangement according to claim 3, wherein the first mould is provided with at least one roller adapted to carry at least a portion of the weight of the first mould, the distance between the roller and the second mould being shorter than the distance between the second element connection and the second mould, at least in the open mould position.

9. The wind turbine blade manufacturing arrangement according to claim 8, wherein the distance between the roller and the second mould is shorter than the distance between the centre of gravity of the first mould and the second mould, at least in the open mould position.

10. A method for manufacturing a wind turbine blade using a manufacturing arrangement comprising a first mould and a second mould connected by a hinge mechanism and presenting respective elongated first and second moulding surfaces, the method comprising rotating the first mould, from an open mould position to a mould closing position, in a first and a second rotation step, wherein during at least a part of the first rotation step, the first mould undergoes a combined rotational and a translational movement.

11. The method according to claim 10, wherein the first mould is translated, in the first rotation step, away from the second mould.

12. The method according to claim 10, further comprising rotating, during the first rotation step, at least one rotation element around a first element connection between the rotation element and a fixing unit which remains fixed during the first rotation step, and simultaneously rotating the first mould around a second element connection between the first mould and the rotation element, the distance between the second element connection and the second mould being, at least when the first mould is in the open mould position, shorter than the distance between the first element connection and the second mould.

13. The method according to claim 12, wherein the distance between the centre of gravity of the first mould and the second mould is, at least when the first mould is in the open mould position, shorter than the distance between the second element connection and the second mould.

14. The method according to claim 12, wherein the rotation element rotates in the opposite direction in relation to the first mould.

15. The method according to claim 12, wherein the first mould rotates during the first and a second rotation step around a first and a second axis of rotation, respectively, and the distance between the second axis of rotation and the second mould is, at least in the open mould position, shorter than the distance between the second element connection and the second mould.
